(19) United States
(12) Patent Application Publication
(10) Pub. No.: US 2013/0111430 A1
(43) Pub. Date: May 2, 2013

(54) PROVIDING GOODS OR SERVICES

(71) Applicants: Yin Wang, Palo Alto, CA (US); Ahmed M. Nazeem, Atlanta, GA (US); Ram Swaminathan, Cupertino, CA (US)

(72) Inventors: Yin Wang, Palo Alto, CA (US); Ahmed M. Nazeem, Atlanta, GA (US); Ram Swaminathan, Cupertino, CA (US)

(21) Appl. No.: 13/282,632

(22) Filed: Oct. 27, 2011

(51) Int. Cl. G06F 9/44

(52) U.S. Cl. 717/104

(57) ABSTRACT

An exemplary embodiment of the present may provide goods or services by selecting component services, and computing an automaton from the component services. A Petri net may be generated from the automaton using a theory of regions, and the Petri net may be executed to optimize the provision of goods or services.

### BACKGROUND

A Service Oriented Architecture (SOA) is a set of methodologies used to guide the design and development of software in the form of interoperable services. The interoperable services can be reused for multiple purposes throughout the SOA, in a variety of combinations called service compositions. Typically, workflows are used to organize, orchestrate, and provide services in a service composition to achieve various business objectives. Workflows are high level scripting languages that organize various operations into structures such as AND, OR, and sequence. The workflows are often constructed manually, which is a tedious, time consuming, and error prone process. Manually composed workflows are poorly optimized, and maintaining these workflows can use additional processes that are also tedious, time consuming, and error prone.

Automated service composition allows a large number of services to be automatically organized into a service model in order to provide services and achieve various business objectives. Service models can be largely divided into three categories of service models: Input/Output models, Precondition/Effect models, and Stateful models. Each type of service model results in different composition algorithms that generate a composite service from a set of component models, referred to as a service composition, to achieve a given business objective or goal. The output composite service is often represented by ad-hoc workflows that omit detailed composite service representation for the sake of simplicity, and may not represent all possible paths to achieve composition goals. Further, these ad-hoc workflows describe little to no concurrency, which refers to the simultaneous occurrence of operations and transitions during the execution of the composite service or workflow.

### BRIEF DESCRIPTION OF THE DRAWINGS

Certain exemplary embodiments are described in the following detailed description and in reference to the drawings, in which:

FIG. 1 is a diagram representing an automaton 100 for a data type in an Input/Output service model in accordance with embodiments;

FIG. 2A is a diagram showing four input/output pairs 200 of an Input/Output model in pairs in accordance with embodiments;

FIG. 2B is a diagram 210 showing automata for five data types in accordance with embodiments;

FIG. 2C is a diagram of the parallel product of the automata 262 for five data types in accordance with embodiments.

FIG. 3 is a diagram of the automaton 300 for literal I in Precondition/Effect service models in accordance with embodiments;

FIG. 4 is a process flow diagram of a method 400 of providing goods and services in accordance with embodiments;

FIG. 5 is a diagram showing the labeled Petri net 500 generated by traditional synthesis methods;

FIG. 6 is a diagram showing the labeled Petri net 600 generated by Algorithm 1 in accordance with embodiments;

FIG. 7 is a block diagram of a system 700 that may provide goods or services according to an embodiments; and

FIG. 8 is a block diagram showing a non-transitory, computer-readable medium 800 that stores code for providing goods or services in accordance with embodiments.

### DETAILED DESCRIPTION OF SPECIFIC EMBODIMENTS

In embodiments, a workflow can represent a set of variables. The variables can be manipulated by operations of the workflow that include service invocation, user interaction, value assignment, and utility functions. One automaton may be built for each variable used in the workflow. The automaton includes operations as transitions and captures the life cycle of the variable. A set of automata may be used to represent component services in a service repository. A composite service representation is obtained from the parallel product of the automata within the service repository, called a parallel product automaton. A Petri net may be constructed from the parallel product automaton using Petri net synthesis algorithms. In embodiments, a theory of regions can be applied to the parallel product automaton to find the optimal representation of composition.

Further, in embodiments, a composite service representation includes alternative solutions for providing goods and services according to the particular composition goal, and the composite service representation expresses full parallelism that an execution engine can exploit at runtime. Full parallelism refers to maximum concurrency, such that during any execution path, all operations that can be executed concurrently are allowed to be executed concurrently by the composite service representation. Additionally, in embodiments, the composite service representation is compact so that human operators can understand and reason about the particular composite service representation.

In order to build a composite service representation, a set of component service models with a composition goal may be used as input, and a composite service representation may be generated, usually represented by a workflow, that achieves the composition goal. A component service typically consists of a set of atomic operations. In the Input/Output service model, an operation of the component service is modeled as a pair of input and output sets. In the Precondition/Effect model, an operation of the component service is modeled as a pair of precondition and effect sets, which are logic literals representing typically the state of the component service. Finally, in the Stateful service model, the component service is modeled by stateful models, such as finite state automata, to describe its state. The operations in the Stateful service model are transitions in the automata that change the states of the model. The Stateful service model is the most expressive model, and can capture the semantics of the both the Precondition/Effect and Input/Output service models. A service semantic is a requirement or condition that should occur to invoke a particular service. Additionally, the Precondition/Effect service model is more expressive than the Input/Output service model, and can be used to capture the semantics of the Input/Output service model. However, the more expressive models are generally more difficult to construct and have a higher computation complexity. In practice, there is no widely adopted standard for the purpose of composite service representation. Table 1 summarizes the tradeoff between the various service models.

TABLE 1
Types of Service Models

| Model | Features | Service Description | Standard |
|---|---|---|---|
| Input/Output | interface only, service | input and output | WSDL |
| | has no semantics | data schema | |
| Precondition/ | semantics only, | preconditions and | OWL-S |
| Effect | service is stateless | effects, situation | (draft) |
| | | calculus | |
| Stateful | service has states, | states and transition | |
| | most expressive | function | |

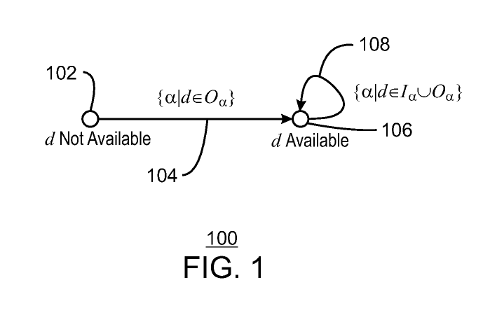

FIG. 1 is a diagram representing an automaton 100 for a data type d in an Input/Output service model in accordance with embodiments. In the Input/Output service model, an operation α of a service is defined by an Input/Output pair (I_{α}, O_{α}), where I_{α} is the input data set and O_{α} is the output data set. The execution semantics of the Input/Output model is such that in order to execute α, I_{α} is generated by services executed preceding α. After its execution, O_{α}, is added to a set of available data. To compose Input/Output services using automata, an automaton may be constructed for both the input data and the output data as shown by automaton 100.

An automaton for a data type d has two states representing the availability of d. At reference number 102, a circle at the initial state represents the unavailability of d. Operations that generate d as an output can take place at the transition at reference number 104 and move the automaton to the circle at the final state at reference number 106 representing the availability of d. Accordingly, operations that use d as input take place at the final state at reference number 106. Operations that output d can occur at the final state at reference number 106, since they would otherwise be prohibited after the parallel product operation. The self-loop at reference number 108 allows the operations that output d to occur at the final state. By defining the operations with automata, undefined transitions are prohibited by default, according to the semantics of each automaton. Thus, if a particular operation does not have a corresponding transition, it is prohibited. Modeling Input/Output services using automata ensures that an operation generating some data will precede any operation that uses the data. Moreover, the parallel product preserves such an ordering precedence among automata.

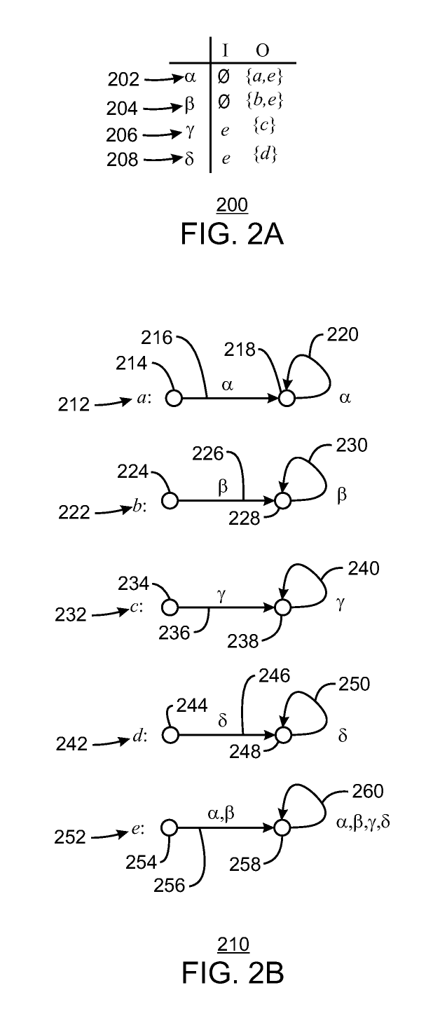

FIG. 2A is a diagram showing four input/output pairs 200 of an Input/Output model in accordance with embodiments. The pairs 200 include four operations with operation α at reference number 202, operation β at reference number 204, operation γ at reference number 206, and operation δ at reference number 208, with the corresponding Input/Output pairs in the same row as the operation in the pairs 200.

Operation α in the row at reference number 202 has no input, as noted by the empty set in the input column, labeled ‘I’. In other words, the operation α may take place at any time, because there is no input that has to be present for operation α to occur. The output of operation α is data types a and e as shown in the row at reference number 202 in the output column, labeled ‘O’. The output data types a and e can be used as input to other operations. Operation β in the row at reference number 204 has no input, similar to operation α. Like operation α, operation β may take place at any time. The output of operation β is data types b and e, as shown in the row at reference number 204.

Operation γ in the row at reference number 206 has e as input. Data type e may be the output of operation α or operation β, as shown in the output columns of operation α at reference number 204 or operation β at reference number 206. The output of operation γ is data type c. Similarly, operation δ in the row at reference number 208 has e as input. The output of operation δ is data types d.

The operations and data types may represent various tasks done in order to provide goods or services. For example, operation α may represent the calculation of shipping costs. The shipping costs may be calculated at any time, as there is no input to operation α. The output of operation α may indicate that the shipping costs are available, and can be represented by data type e. In turn, when data type e is available, operation γ can be performed, which can represent charging a credit card. The output of charging the credit card may be providing notice that the credit card was in fact charged, and can be represented by data type c.

FIG. 2B is a diagram 210 showing automata for five data types in accordance with embodiments. FIG. 2B shows how the input/output pairs from FIG. 2A are converted into automata. The automaton for data type a is at reference number 212. The automaton 212 has an initial state at reference number 214. A transition that corresponds to operation α occurs across the arrow at reference number 216 to take the data type a to the final state at reference number 218. The self-loop at reference number 220 allows for the data type a to be an input to the operation α and return to the final state at reference number 218.

Like the automaton at reference number 212, the automaton for data type b is at reference number 222. The automaton 222 has an initial state at reference number 224. A transition that corresponds to operation β occurs across the arrow at reference number 226 to take the data type b to the final state at reference number 228. The self-loop at reference number 230 allows for the data type b to be an input to the operation β and return to the final state at reference number 228.

The automaton for data type c is at reference number 232. The automaton 232 has an initial state at reference number 234. A transition that corresponds to operation γ occurs across the arrow at reference number 236 to take the data type c to the final state at reference number 238. The self-loop at reference number 240 allows for the data type c to be an input to the operation γ and return to the final state at reference number 238.

The automaton for data type d is at reference number 242. The automaton 242 has an initial state at reference number 244. A transition that corresponds to operation δ occurs across the arrow at reference number 246 to take the data type d to the final state at reference number 248. The self-loop at reference number 250 allows for the data type d to be an input to the operation δ and return to the final state at reference number 248.

The automaton for data type e is at reference number 252. The automaton has an initial state at reference number 254. A transition occurs across the reference number 256 to take the data type e to the final state at reference number 258. The transition may correspond to operation α or operation β. The self-loop at reference number 260 allows for the data type e to be an input to operation α, operation β, operation γ, or operation δ and return to the final state at reference number 258.

FIG. 2C is a diagram of the parallel product of the automata 262 for five data types in accordance with embodiments. Each circle represents an initial state or a final state. For example, the circle at 264 represents an initial state, as the operation α occurs when transitioning from the circle 264 to the circle 266. Operation β may occur when transitioning from the circle 264 to the circle 268. Both the circle 266 and the circle 268 can represent both an initial state and a final state, depending the operation or transition that occurs. Circle 270 represents a final state, and the operation α, operation β, operation γ, or operation δ occurs to arrive at the final state at circle 270. Although not shown, the self-loops 220, 230, 240, 250, and 260 (FIG. 2B) that occur within each automaton do occur at each circle that is also a final state within the parallel product of the automata 262. Since the Input/Output model expresses the operations in terms of an initial state and a final state across various transitions, an ordering preference among the operations is preserved in the parallel product. Additionally, the semantics of the Input/Output model maintains each feasible path between the operations and also the parallelism between each path.

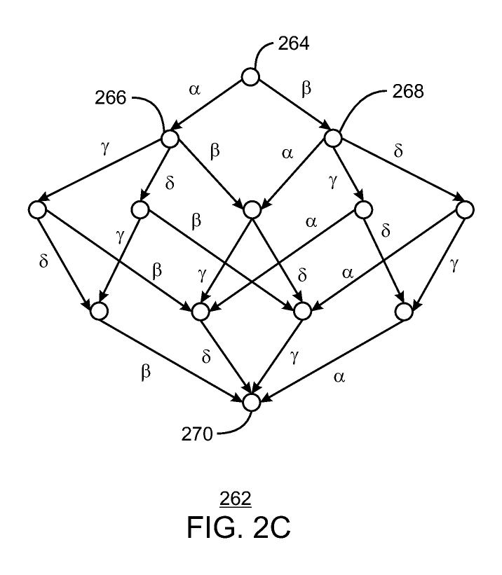

FIG. 3 is a diagram of the automaton 300 for literal I in Precondition/Effect service models in accordance with embodiments. The Precondition/Effect model describes the service semantics using propositional literals. Formally, the Precondition/Effect model of an operation α is a triple (P_{α}, E_{α}⁺, E_{α}⁻), where P_{α} is the set of literals representing preconditions, E_{α}⁺ represents positive effects, and E_{α}⁻ represents negative effects. An effect is an occurrence that changes the precondition, and positive effects represent the opposite of negative effects. Positive effects and negative effects can be separated to facilitate the use of set operations.

A current state T is a set of literals that are true in the state. Literals not in T are assumed to be false, also known as a closed-world assumption. The operation α can take place in T if P_{α}⊂T, and once a takes place, the next state is defined as T⊂E_{α}⁺−E_{α}⁻. In other words, to execute an operation α, all literals in P_{α} must be true in the current state. After the execution of operation α, E_{α}⁺ is added to the state, while E_{α}⁻ is removed.

The automaton for the Precondition/Effect service model is similar to the automaton representing Input/Output models in FIG. 2C. At the circle 302, there is an initial state where operation α begins with a literal I. The self-loop 304 represents the set of operations that can be performed at the initial state 302 of I without affecting the initial state 302. As the literal I transitions from the initial state at circle 302 to the final state at circle 306, one of two conditions may occur. A positive effect on literal I can occur, such that the literal I is contained within the set E_{α}⁺ at reference number 308. Alternatively, a negative condition may occur such that the literal I is contained within the set E_{α}⁻ at reference number 310. The self-loop at 312 represents the set of operations that can be performed at the final state 306 of I without affecting the final state 306. The loop at reference number 314 allows the operation α to be performed on the new literal I that is obtained at the final state 306, depending on the business composition goals.

As an example, the Precondition/Effect model can be used to model the operation α, where operation α represents the calculation of shipping costs. In the Precondition/Effect model the semantics of the operation are modeled, with no states or data types are included in the model. A positive effect may be included, such as the shipping costs are available. A negative effect is the opposite of the positive effect, and in this particular example could be the shipping costs are not available. The Precondition/Effect model does not model what can happen to the various data types as a result of the operations. Since no states or data types are modeled, the Precondition/Effect model is more generalized when compared to the Input/Output model.

Operations that have I in their positive or negative effect set will move the automaton to the corresponding states. Operations that require I as a precondition will take place when I is true. In practice, enumeration data types, instead of Boolean values, are often used for expressing preconditions and effects. For example, in an online checkout service, if the order status has a state of “chargeable,” a merchant can issue a “charge” operation and the effect is that the state becomes “charged.” With an enumeration data type, instead of encoding the state into Boolean formulae, one automaton can be used for the variable.

Additionally, in practice, Precondition/Effect service models often have conditional effects. For example, a “charge” operation may result in a successful charge or a declined payment. Conditional effects may be captured by branches in the automaton. Accordingly, one operation may be split into one transition that represents its invocation, and a set of successor transitions that' represent different effects.

While both Input/Output and Precondition/Effect models describe each operation of a service separately, Stateful models consider the service as one system with states, and its operations are transitions that can change its state. For example, in the online checkout example, instead of using precondition “chargeable” and effect “charged” to describe the operation, the automaton may have states “chargeable,” and “charged,” with the transition “charge” in between the states. As a result, the Stateful service model shares the same set of transitions with the automata that are used for Input/Output and Precondition/Effect services models, and is a different technique used to capture the service semantics.

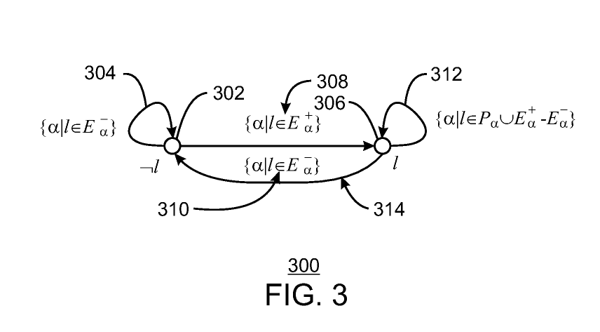

FIG. 4 is a process flow diagram of a method 400 of providing goods and services in accordance with embodiments. At block 402 a set of component services represented by automaton models is selected. The component services are modeled using existing composition models, such as Input/Output service models, Precondition/Effect service models, and Stateful service models, without changing the service semantics or their respective description language. The automata of each service model may be placed into a service repository.

At block 404, an automaton is computed from the set of component services. An automaton g is a triple (S_{g}, Σ_{g}, Δ_{g}, s_{0g}), where S_{g} is a finite set of states, Σ_{g} is a set of event labels, partial function Δ_{g} : S_{g}×Σ_{g}→S_{g} is the transition function, and s_{0g} is the initial state. When component services are modeled by automata, the single automaton of the composite service is found by taking the parallel product of automata that represent the component services.

The parallel product of automata g and h is an automaton g∥h=(S_{g}×Sₕ, Σ_{g} ∪ΣZ_{hΔg∥h}, (s_{og}, s₀ₕ))

$$Δ g ‖ h \text{:} ( s , t ) α ) \to \{ \begin{matrix}( {s}^{′} , t ) & if Δ g ( s , α ) is defined \\ ( s , {t}^{′} ) & if Δ h ( t , α ) is defined \\ ( {s}^{′} , {t}^{′} ) & if both are undefined \\ & undefined otherwise\end{matrix}$$

where s′=Δ_{g}(s, α), t′=Δₕ(t,α) are successor states of s and t, respectively.

In embodiments, a composite service model that corresponds to the automaton found from the set of component services may be built. In order to build a composite service model, a composition goal may be used as the input, the relevant automaton models may be selected from the service repository, and the parallel product of the service models' automata can be used to build the composite service that achieves the given goal. For example, let G denote the set of automata found in a service repository that contains the automata of the service models. Each component automaton in the service repository may represent the life cycle of some data object, and the composition task is naturally specified as pairs of initial and goal states for a subset of component automata, denoted as G′⊂G. Since this subset must be included in the composition, the set G′ may be expanded until all relevant component automata are included in the set G′. Taking the parallel product synchronizes automata on shared operations, therefore all automata that share operations with those in G′ must be included, such that, G′=G′ ∪{g|g ∈ G\G′, ∃h ∈ G′, Σ_{g} ∩ Σₕ≠0}. The set G′ is expanded until no new automata can be added to G′.

An optional pruning step can be used in building the composite service model that reduces the number of component automata included in exchange for a less flexible Petri net in the solution. The pruning may include pruning dead states in each component automaton. Dead states are states that are not reachable from the initial state or states that cannot reach the goal state. Pruning does not reduce alternative paths in the composite service to reach the goal, but the composite service may become undefined should the execution lead to those dead states unexpectedly. Additionally, alternative paths may be pruned for a small composite automaton. For example, with a map navigation composition service, a simple solution, such as one navigation route, may be sufficient rather than numerous alternative navigation routes.

The computational complexity of building the composite service model depends on the size of the final composite. The parallel product constructs the Cartesian product for the state sets of all automata involved in the operation. With many shared operations among components, in practice, the state space is much smaller than the full Cartesian product. Pruning can further reduce the number of automata in the final composite.

At block 406, a Petri net is generated from the automaton using a theory of regions. A Petri net N=(P, Π, A, M₀) is a bipartite graph, where P is the set of places, Π is the set of transitions, A⊂(P×Π)∪(Π×P) is the set of arcs, and for each p ∈ P, M₀(p) is the initial number of tokens in place p. Petri net synthesis may occur that uses the theory of regions to convert an automaton to an unlabeled Petri net, whenever such a conversion exists. Through Petri net synthesis and the theory of regions, a reachability graph may be constructed that is structurally identical, or isomorphic, to the given automaton.

Petri nets are bipartite directed graphs with two types of circles: circles that represent places and solid bars that represent transitions. Tokens in places are shown as dots. A transition α in a Petri net is enabled if every input place p of α, such that (p, α)∈ A, has at least one token in it. When an enabled transition α fires, one token is removed from every input place p of α, and adds one token to every output place q of α, such that (α, q)∈ A. This type of Petri net may be referred to as ordinary. A non-ordinary Petri net N=(P, Π, A, W, M₀) assigns weight to each arc W: A→N. In this case, the firing of a transition a will take W(p, α) tokens from each input place p, and replenish W(α,q) tokens to each output place q.

Let P={p₁, . . . , pₙ}, which is the marking, or state, of a Petri net, and records the number of tokens in each place. The marking P is represented as a column vector M of dimension n×1 with non-negative integer entries, using a fixed order for the set of places: M=[M(p₁) . . . M(pₙ)]^{T}, where T denotes the transpose. As defined above, M₀(pᵢ) is the initial marking of pᵢ. A self-loop in a Petri net is a pair p, α such that (p, α), (α, p)∈ A. The present techniques use Petri nets without self-loops, also called pure Petri nets.

The reachable state space of a Petri net is the set of all markings reachable by transition firing sequences starting from M₀. This state space may be infinite if one or more places contain an unbounded number of tokens. The present techniques use Petri nets with a bounded number of tokens, also called a bounded Petri net. Given a Petri net N=(P, Π, A, M₀), a reachability graph can be constructed that is an automaton (S, Σ, Δ, s₀), where S represents all reachable markings of N from M₀, Σ=Π, and Δ captures the dynamics of N, such that Δ(M₁, α)=M₂ if and only if α∈ Π is enabled at marking M₁, and the firing of α at M₁ leads to the marking M₂.

A labeling function L may be added to label the Petri net, such that N=(P, Π, A, L, Ψ, M₀) where L: Π→Ψ. The dynamics of a labeled Petri net are the same as an unlabeled one, but the reachability graph is slightly modified as Σ=Ψ and Δ(M₁, α)=M₂ if and only if β∈ Π changes the marking M₁ to M₂ and L(β)=α.

At block 408, the Petri net is executed to optimize the provision of goods or services. The Petri net with a reachability graph that is isomorphic to the automaton can represent all possible paths to achieve composition goals with full concurrency. Concurrency refers to the simultaneous occurrence of operations and transitions within the Petri net. Further, the original semantics of the composite service representation are maintained. For example, a business may have a composition goal that includes the ability to complete sales online. The operations in the Petri net include calculating shipping costs or charging credit cards during a purchase.

When a Petri net is generated from the automaton using a theory of regions, a region is a set of states in an automaton where every set of transitions with the same event label is one of the following: all “enter” the region, all “leave” the region, none “enters” or “leaves” the region, or irrelevant. Consider the synthesis of an unlabeled Petri net, and let Π=Σ. A region maps to a place in the Petri net, where event labels that enter the region become input transitions of the Petri net, and event labels that leave the region become output transitions of the Petri net. Therefore, a place p has one token in some marking M if and only if the automaton state corresponding to M is in the region corresponding to p. Such a Petri net is considered an elementary Petri net, where there is no more than one token in one place in any reachable marking.

While the state set based region maps every event label to one of the three cases, “enter,” “leave,” and “irrelevant,” the generalized region maps a label to an arbitrary integer. The label may be represented as an integer vector over all event labels. During synthesis, the vector region maps to a place p in the Petri net, and its vector represents p′s connectivity with all transitions. A bounded, unlabeled Petri net is a superset of elementary net, but its reachability graphs are still a strict subset of all automaton models. Therefore, the conversion from an automaton to a bounded unlabeled Petri net, or an elementary net, may not exist. In this case, conflicting transitions may be re-labeled, and a labeled Petri net can be synthesized. Alternatively, the automaton may be pruned as discussed herein, and an unlabeled Petri net may be synthesized. Relabeling the conflicting transitions can reduce concurrency, even though the reachability graph remains isomorphic to the given automaton. The alternative of pruning loses both flexibility and concurrency.

Formally, in an automaton (S, Σ, Δ, s₀), a set of states R ⊂ S is a region if and only if, for any pair of equally labeled transitions Δ(s, α)=s′, Δ(t, α)=t′, the following holds: if s ∈ R and s′∉R then t ∈ R and t′∉R, and if s ∉ R and s′ ∈ R then t ∉ R and t′ ∈ R. If an event α “leaves” region R, R is a pre-region of α. If α “enters” R, R is a post-region of α. The set of all pre-regions of α is denoted as ∘α. The set of all post-regions is denoted as α∘. Given a set R of regions for automaton (S, Σ, Δ, s₀), an unlabeled Petri net (P, Π, A, M₀) may be constructed by first letting P=R and Π=Σ. In other words, add one place per region and one transition per event label. Then (p, α) ∈ A if and only if the region of p is a pre-region of α, and (α, p) ∈ A if and only if the region of p is a post-region of α. A place has one initial token in M₀ if and only if its region contains the initial state s₀.

A set R of set regions can map to an elementary Petri net whose reachability graph is isomorphic to (S, Σ, Δ, s₀) if and only if the following two conditions hold:

∀s, t ∈ S, ∃R ∈ R such that s ∈ R, t ∉ R or s ∉ R, t ∈ R (1)

∀s ∈ S, α∈ Σ, Δ(s, α) undefined→∃R ∈ R, R ∈∘α, s∉ R (2)

Equation (1) is a state separation condition, which ensures that different states in the automaton map to different markings in the Petri net. This is achieved by finding a region that includes one state but not the other. As a result, the region's corresponding place will have one token in one state, or marking, and zero tokens in the other.

Equation (2) is an event separation condition, which ensures that an event α not defined at a state s will be prohibited by some place in the marking that corresponds to s. This is achieved by a pre-region of α that does not include s. This region, or place, is connected to α but the region does not have any token in the marking that corresponds to s, and therefore α is prohibited at s.

The implementation of Equation (2) may not be practical due to Equation (2) ensuring one region for each undefined pair (s, α). Sparsely connected automata, such as automata without many transitions, would have more places in the converted Petri net using Equation (2). An alternative event separation condition that enables efficient place reduction techniques is the following condition:

∀α ∈ Σ, ∘α ≠0 and ∩_{R∈∘α}R=pre-states of α (3)

where pre-states of a are states for which α is defined.

Equation (3) is equivalent to (2). However, the number of places may be reduced by first finding all pre-regions of an event, and then selecting the minimum combination of regions that satisfies Equation (3). The final result is not the minimum-size Petri net though, since it is possible to combine pre-regions of different events and further reduce the number of places. However, the minimum-size Petri net is not a good optimization goal in this instance because combining pre-regions of different events can destroy structures of the Petri net and make it unnecessarily complex.

Equation (3) is also limited to elementary Petri nets. As a result, the conversion to such a Petri net may not exist even for the simplest Input/Output model-based composition. For example, the parallel product automata in FIG. 3C cannot be converted into an elementary net. The event separation condition does not hold for the starting state and event α or δ. In order to satisfy the event separation condition of Equation (3), event labels within the set region framework may be split where the event separation condition is violated, and the corresponding automata may be converted into a labeled Petri net. Event splitting reduces the concurrency in the converted Petri net. Further, if every transition in the automaton has a different label, the resulting Petri net generated would be totally sequential, just as the automaton model.

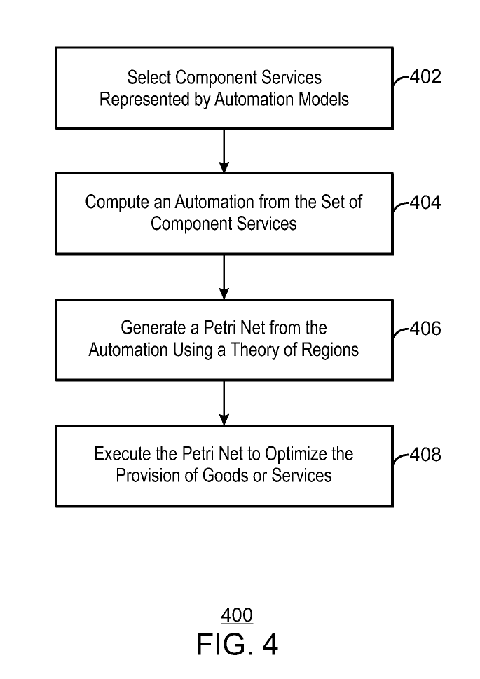

FIG. 5 is a diagram showing the labeled Petri net 500 generated by traditional synthesis methods. Traditional Petri net synthesis methods are applied to the operations described in FIGS. 2A-2C. Within the Petri net, operations are referred to as events. Event α is split between reference numbers 502 and reference number 504, while event β is split between reference number 506 and reference number 508. Since they are split, event α and event β cannot take place in parallel after the conversion from an automaton to the Petri net. Each circle, such as the circle at reference number 510, represents a place. A token 512 is shown within the circle at reference number 510. Each solid bar, such as the solid bar at reference number 514, represents a transition.

A set of vector regions may also map to a non-ordinary Petri net. A vector region of an automaton (S, Σ, Δ, s₀) is a mapping V: Σ→Z. First let P=R and Π=Σ. Each vector region V ∈ R represents the connectivity of its corresponding place, say p, with the transitions in the Petri net, such that (α, p) ∈ A and W(α, p)=V(α) if V(α) is positive, or (p, α) ∈ A and W(p, α)=−V(α) if V(α) is negative, otherwise there is no arc between p and α if V(α)=0. With the above Petri net construction, if a path u of transition firing sequence is followed, the token change in a region, or place, V would be the weighted sum of the integer vector of V, where the weight of event label α is the number of occurrences of α in u. With this observation, a set of regions can be found to achieve the synthesis goal through linear programming. More specifically, if different paths are followed to reach a state in the automaton, each region will have exactly the same number of tokens. This can be achieved by finding all undirected elementary cycles in the automaton and formulating them as equality constraints in the linear programming formula. The constraint states that each cycle evaluates to zero in the weighted sum of a vector region, and going through a cycle does not change the number of tokens in a place. In addition, each place will have nonnegative number of tokens in every reachable state. Therefore, an inequality constraint is added to the linear programming, stating that the weighted some of a path to a state is nonnegative. With this linear programming formulation, a different characterization of the state separation and event separation conditions may be presented using vector regions. For ease of description, the number of tokens in a vector region V in state s may be denoted as Vₛ.

Thus, a set R of vector regions maps to a bounded Petri net whose reachability graph is isomorphic to (S, Σ, Δ, s₀) if and only if the following two conditions hold:

∀s, t ∈ S, ∃V ∈ R such that V(s) ≠V(t) (4)

∀s, α, Δ(s, α) undefined→∃V ∈ R, V(s)+V(α)<0 (5)

The state separation condition in (4) ensures that for each pair of states, there is at least one place such that its number of tokens in the two corresponding markings would be different. In other words, different states do not map to the same marking. The event separation condition in (5) states that for every undefined state event pair (s, α), there is a place in the Petri net with insufficient number of tokens to disable a at the marking corresponding to s.

Vector region and its linear programming method can convert automata into unbounded Petri nets, which is a superset of elementary Petri nets. However, it suffers from the same problem with the conditions in Equation (1) and Equation (2), where the number of places generated can be large. The place reduction technique corresponding to Equation (3) does not apply to vector regions. Moreover, the vector obtained from the linear programming method may have too many non-zero entries, which map to numerous arcs connected to the place, and can complicate the Petri net representation.

The notion of a vector region is a generalization of the notion of a set region. A set region R can be converted to a vector region V as follows, V(α)=1 if R is a post-region of α, V(α)=−1 if R is a pre-region of α, otherwise V(α)=0. Therefore, the Petri net generated by the translated vector regions is the same as the Petri net generated by the set regions directly. Thus, an automaton g=(S, Σ, Δ, s₀) is isomorphic to the reachability graph of some unlabeled and bounded Petri net if for each pair of s, a, if Δ(s, α) is undefined, there exists a set or a vector region that satisfies Equation (2) or Equation (5), respectively.

A Petri net can be synthesized by combining both set regions and vector regions. Furthermore, optimization techniques may be applied to Equation (3) to reduce the number of set regions. Algorithm 1 displays such a Petri net synthesis.

Algorithm 1 Petri net synthesis algorithm

| Input: Automaton g = (S.Σ.Δ.s₀) | |
|---|---|
| Output: Petri net N = (P.π.A.M₀), where π = Σ. and the reach- | |
| ability graph is isomorphic to g. | |
| 1: | for all α ♭ Σ do |
| 2: | [symbol] = all minimal pre-regions of α |
| 3: | E = ∩_{R} [symbol] R [symbol] {pre-states of α} |
| 4: | if E ≠ Ø then |
| 5: | for all s ε E do |
| 6: | solve event_seperation_linear_programming(s.α) |
| 7: | if feasible solution found then |
| 8: | add the solution vector region to [symbol] |
| 9: | else |
| 10: | split_event(α) and start all over |
| 11: | end if |
| 12: | end for |
| 13: | end if |
| 14: | end for |
| 15: | remove redundant regions and map to Petri net N |

[symbol]

indicates data missing or illegible when filed

Algorithm 1 begins by finding a set of pre-regions for a number of events within the automaton. Then it is determined if the set of pre-regions for each event satisfy an event separation condition, and it is determined if a vector region satisfies the event separation condition for each event that has pre-regions that do not satisfy an event separation condition. The vector region may be added to the set of pre-regions if the vector region satisfies the event separation condition. Each event may be iteratively split until the set of pre-regions of each event or the vector region satisfies the event separation condition. When the event separation condition is satisfied, the set of pre-regions may be mapped to a Petri net.

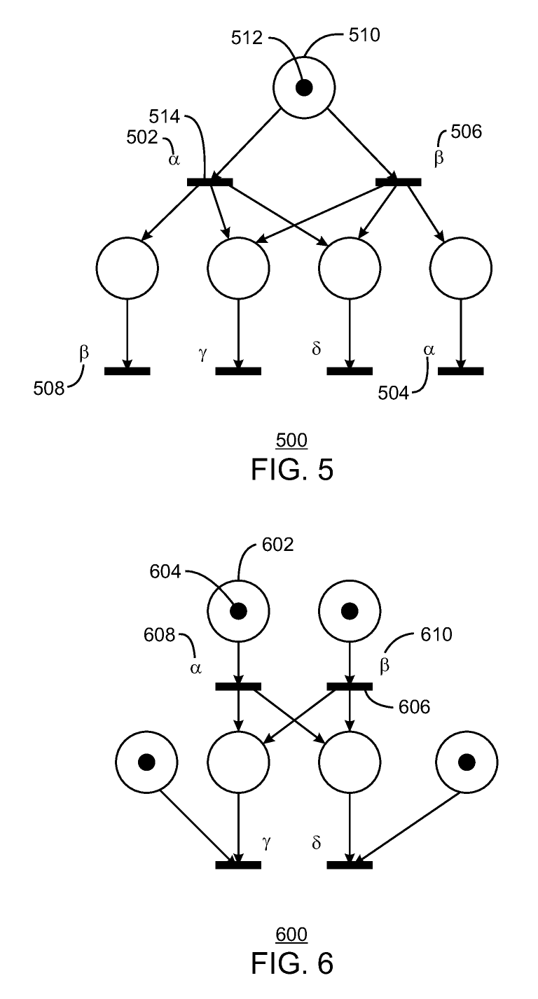

FIG. 6 shows the labeled Petri net 600 generated by Algorithm 1 in accordance with embodiments. The techniques of Algorithm 1 are applied to the operations described in FIGS. 2A-2C. The resulting Petri net allows fully concurrent execution. Each circle, such as the circle at reference number 602, represents a place. A token 604 is shown within the circle at reference number 602. Each solid bar, such as the solid bar at reference number 606, represents a transition. In FIG. 6, event α at reference number 608 and event β at reference number 610 are not split. Accordingly, event α at reference number 608 and event β at reference number 610 can take place in parallel after the conversion from an automaton to the Petri net 600. As a result, the Petri net 600 allows for parallel execution of event α and event β. Further, full concurrency is maintained in Petri net 600.

If set regions are used, event splitting is used and the concurrency is reduced. If structures are limited to AND or OR within the Petri net, the result will not achieve the same level of concurrency as FIG. 6. For example, a typical solution puts α and β in an AND structure. Operations γ and δ may be placed in another AND structure that succeeds the first AND. In this case operation γ and operation δ have to wait until both operation α and operation β finish. If operation γ and operation δ are waiting, the Petri net may have a significant performance penalty, especially if one of operation α or operation β is much slower than the other. Petri net 500 (FIG. 5) shows that if a typical workflow representation for the composition result is used, full concurrency cannot be obtained even for the simplest Input/Output service model.

The linear programming formulation at line 6 of Algorithm 1 uses an optimization goal to minimize the connection of region V with transitions in the Petri net. In other words, the number of non-zero mappings in V are minimized. In this manner, the Petri net obtained using Algorithm 1 has fewer arcs. In many cases, the Petri net synthesized from Algorithm 1 is essentially a workflow net that can be converted into workflow languages like the Business Process Execution Language (BPEL) straightforwardly. However, with the optimization goal, the formulation becomes an integer programming problem rather than linear programming.

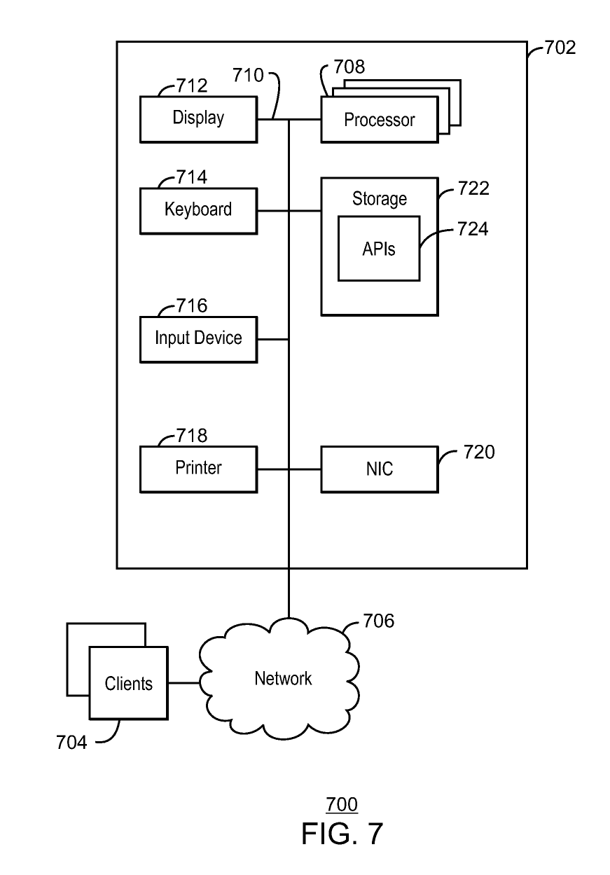

FIG. 7 is a block diagram of a system that may provide goods or services according to an embodiment of the present techniques. The system is generally referred to by the reference number 700. Those of ordinary skill in the art will appreciate that the functional blocks and devices shown in FIG. 7 may comprise hardware elements including circuitry, software elements including computer code stored on a tangible, machine-readable medium, or a combination of both hardware and software elements. Additionally, the functional blocks and devices of the system 700 are but one example of functional blocks and devices that may be implemented in an embodiment. Those of ordinary skill in the art would readily be able to define specific functional blocks based on design considerations for a particular electronic device.

The system 700 may include a server 702, and one or more client computers 704, in communication over a network 706. As illustrated in FIG. 7, the server 702 may include one or more processors 708 which may be connected through a bus 710 to a display 712, a keyboard 714, one or more input devices 716, and an output device, such as a printer 718. The input devices 716 may include devices such as a mouse or touch screen. The processors 708 may include a single core, multiple cores, or a cluster of cores in a cloud computing architecture. The server 702 may also be connected through the bus 710 to a network interface card (NIC) 720. The NIC 720 may connect the server 702 to the network 706.

The network 706 may be a local area network (LAN), a wide area network (WAN), or another network configuration. The network 706 may include routers, switches, modems, or any other kind of interface device used for interconnection. The network 706 may connect to several client computers 704. Through the network 706, several client computers 704 may connect to the server 702. The client computers 704 may be similarly structured as the server 702.

The server 702 may have other units operatively coupled to the processor 708 through the bus 710. These units may include tangible, machine-readable storage media, such as storage 722. The storage 722 may include any combinations of hard drives, read-only memory (ROM), random access memory (RAM), RAM drives, flash drives, optical drives, cache memory, and the like. The storage 722 may include application programming interfaces (APIs) 724. Through the APIs 724, the server 702 may be used to provide some functionality to the client computers 704, such as an online payment processing service. The APIs may be designed with flexibility such that merchants of various size and complexity can use the various APIs for their respective composite service representations. Different online payment processing systems result in different integration and composite service representations for each of the client computers. The services from the APIs 724 may be provided by deriving a Petri net using a theory of regions.

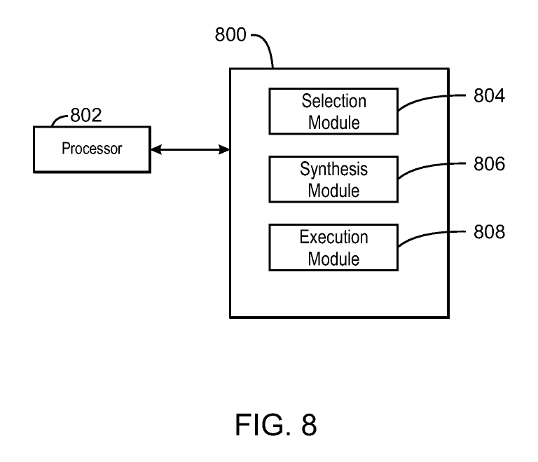

FIG. 8 is a block diagram showing a non-transitory, computer-readable medium that stores code for providing goods or services according to an embodiment of the present techniques. The non-transitory, computer-readable medium is generally referred to by the reference number 800.

The non-transitory, computer-readable medium 800 may correspond to any typical storage device that stores computer-implemented instructions, such as programming code or the like. For example, the non-transitory, computer-readable medium 800 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 802 generally retrieves and executes the computer-implemented instructions stored in the non-transitory, computer-readable medium 800 for providing goods or services. At block 804, a selection module may select component services represented by automaton models. The selection module may also compute an automaton from the component services. At block 806, a synthesis module may generate a Petri net from the automaton using a theory of regions. At block 808, an execution module may execute the Petri net to optimize the provision of goods or services.

What is claimed is:

1. A system for linking errors to a particular tape or a particular tape drive, the system comprising:
a processor that is adapted to execute stored instructions; and
a memory device that stores instructions, the memory device comprising processor-executable code, that when executed by the processor, is adapted to:
select component services;
compute an automaton from the component services;
generate a Petri net from the automaton using a theory of regions; and
execute the Petri net to optimize the provision of goods or services.

2. The system recited in claim 1, wherein a reachability graph of the Petri net is isomorphic to the automaton.

3. The system recited in claim 1, wherein deriving a Petri net from the automaton using a theory of regions comprises:
finding a set of pre-regions for a number of events within the automaton;
determining if the set of pre-regions for each event satisfy an event separation condition;
determining if a vector region satisfies the event separation condition for each event that has pre-regions that do not satisfy an event separation condition;
adding the vector region to the set of pre-regions if the vector region satisfies the event separation condition;
iteratively splitting each event until the set of pre-regions of each event or the vector region satisfies the event separation condition; and
mapping the set of pre-regions to the Petri net.

4. The system recited in claim 1, wherein deriving a Petri net from the automaton using a theory of regions comprises removing any redundant regions from a set of pre-regions.

5. The system recited in claim 1, wherein computing the automaton from the set of component services comprises translating the component services into an automaton using a composite service representation algorithm.

6. The system recited in claim 1, wherein the Petri net is unlabeled or bounded.

7. The system recited in claim 1, wherein the composite service model comprises a set of workflows.

8. A method for providing goods or services, the method comprising:
selecting component services;
computing an automaton from the component services;
deriving a Petri net from the automaton using a theory of regions; and
executing the Petri net to optimize the provision of goods or services.

9. The method recited in claim 8, wherein a reachability graph of the Petri net is isomorphic to the automaton.

10. The method recited in claim 8, wherein deriving a Petri net from the automaton using a theory of regions comprises:
finding a set of pre-regions for a number of events within the automaton;
determining if the set of pre-regions for each event satisfy an event separation condition;
determining if a vector region satisfies the event separation condition for each event that has pre-regions that do not satisfy an event separation condition;
adding the vector region to the set of pre-regions if the vector region satisfies the event separation condition;
iteratively splitting each event until the set of pre-regions of each event or the vector region satisfies the event separation condition; and
mapping the set of pre-regions to a Petri net.

11. The method recited in claim 8, wherein deriving a Petri net from the automaton using a theory of regions comprises removing any redundant regions from a set of pre-regions.

12. The method recited in claim 8, wherein computing the automaton from the component services comprises translating the component services into an automaton using a composite service representation algorithm.

13. The method recited in claim 8, wherein the Petri net is unlabeled or bounded.

14. The method recited in claim 8, wherein the composite service model comprises a set of workflows.

15. A non-transitory, computer-readable medium, comprising code configured to direct a processor to:
select component services;
compute an automaton from the component services;
generate a Petri net from the automaton using a theory of regions; and
execute the Petri net to optimize the provision of goods or services.

16. The non-transitory, computer-readable medium recited in claim 15, wherein a reachability graph of the Petri net is isomorphic to the automaton.

17. The non-transitory, computer-readable medium recited in claim 15, wherein deriving a Petri net from the automaton using a theory of regions comprises:
finding a set of pre-regions for a number of events within the automaton;
determining if the set of pre-regions for each event satisfy an event separation condition;
determining if a vector region satisfies the event separation condition for each event that has pre-regions that do not satisfy an event separation condition;
adding the vector region to the set of pre-regions if the vector region satisfies the event separation condition;
iteratively splitting each event until the set of pre-regions of each event or the vector region satisfies the event separation condition; and
mapping the set of pre-regions to the Petri net.

18. The non-transitory, computer-readable medium recited in claim 15, wherein deriving a Petri net from the automaton using a theory of regions comprises removing any redundant regions from a set of pre-regions.

19. The non-transitory, computer-readable medium recited in claim 15, wherein computing the automaton from the component services comprises translating the component services into an automaton using a composite service representation algorithm.

20. The non-transitory, computer-readable medium recited in claim 15, wherein the Petri net is unlabeled or bounded.
